(19) United States
(12) Patent Application Publication
(10) Pub. No.: US 2006/0238192 A1
(43) Pub. Date: Oct. 26, 2006

(54) Automated positioning of mri surface coils

(76) Inventor: Cornelis L. G. HAM, Eindhoven (NL)

Correspondence Address: PHILIPS INTELLECTUAL PROPERTY & STANDARDS, 595 MINER ROAD, CLEVELAND, OH, 44143, US

(21) Appl. No.: 10/565,290

(22) PCT Filed: Jul. 16, 2004
(86) PCT No.: PCT/IB04/51238

§ 371 Date: Jan. 20, 2006

(30) Foreign Application Priority Data
Jul. 25, 2003 (EP) 03102302.1

(51) Int. Cl. G01V 3/00

(52) U.S. Cl. 324/307; 324/309

(57) ABSTRACT

A novel magnetic resonance imaging method is described, which is provided for planning a small Field-of-View for a surface coil (3, 5) at the region of interest of a patient lying on a support movable through the bore of a main magnet. A magnetic resonance signal is generated in an examination zone by means of an RF pulse (7). This magnetic resonance signal is subsequently detected by means of the surface coil and under the influence of magnetic field gradients. A non-selective RF-pulse (7) and a first gradient pulse (8) having a linearly independent spatial direction are generated in temporal succession, so that the position of the surface coil (3, 5) in said spatial direction with respect to the isocenter of the main magnet can be determined by the center of gravity of the Fourier transformed response signals detected by the surface coil.

The invention relates to a magnetic resonance imaging method for planning a small Field-of-View for a surface coil at the region of interest of a patient on a support movable through the bore of a main magnet, wherein a magnetic resonance signal being generated in an examination zone by means of an RF pulse and said magnetic resonance signal subsequently being detected by means of the surface coil and under the influence of magnetic field gradients.

The invention also relates to an MR apparatus and a computer program product for carrying out such a method.

It is generally known to that surface coils have a much smaller geometry as whole body receive coils and will be used for medical diagnosis of a specific small region inside or outside of the patient. The use of a surface coil in MRI systems also reduces the noise contribution from electrical losses in the body compared with a corresponding whole body receive coil. Such surface coils are thus used for localized high resolution imaging. A disadvantage of surface coils is, however, their limited Field-of-View. A single surface coil can only effectively image a region of a subject having lateral dimensions comparable to the surface coil diameter.

In U.S. Pat. No. 6,223,065 proposes an automatic selection of phased array coil elements appropriate for an anatomical region being scanned, without scan room intervention by MRI personnel. A positioning sensor is used to determine the relative position of the surface coil array to the magnetic isocenter of the system. On the basis of the known position relative to the isocenter the phased coil elements appropriate for an anatomical region being scanned can be automatically selected.

In US-A-2002/0186870 an automatic coil selection is based on determining an index gauge for a corresponding k-space data line acquired for each preselected coil during a prescan. The fast scan data is used to determine those coils most sensitive to the Field-of-View and reject coil(s) least sensitive. Using only data acquired with the most sensitive coils. SNR is increased and unwanted artifacts are reduced in the final data acquisition and image reconstruction. Through automatic and adaptive selection/deselection, the method reduces the susceptibility to human error, and therefore results in higher quality images.

An object of the present invention is to provide a magnetic resonance imaging method which supports a more efficient workflow in the magnetic resonance imaging of the patient to be examined.

This object is achieved according to the invention by the magnetic resonance imaging method as defined in claim 1. The invention is based on the insight that the receiver response signal accurately represents the actual position, relative to the object to be examined, of the receiver antenna In particular the ‘centre of gravity’ of the Fourier 10 transformed response signal represents the centre of sensitivity of the receiver antenna. On the basis of the receiver response signal the location of the field-of-view for subsequent acquisition of magnetic resonance signals for imaging may be adjusted. This is carried out by setting the gradient pulses that are applied in an magnetic resonance imaging acquisition sequence that follows the adjustment of the field-of-view According to another aspect to the invention, the object, notably the patient to be examined is positioned within the open space of the magnet of the magnetic resonance imaging system that is employed for magnetic resonance imaging of the patient to be examined. The patient to be examined is positioned by positioning a patient carrier on which the patient is placed. Hence, the workflow for imaging involves less effort because no elaborate procedure is required to bring the field-of-view into correspondence with the position of the patient to be examined, notably the region of interest of the patient to be examined.

The relative adjustment of the field-of-view and the object to be examined can be carried out in one way to position the object with respect to the field-of-view, or, the other way round to set the location of the field-of-view with respect to the location of the object.

According to one aspect of the invention the receiver response signal is generated by a surface coil. The proper adjustment of the field-of-view relative to the object ensures that the in a subsequent magnetic resonance imaging sequence the field-of-view is in good correspondence with the position of the surface coil.

According to a further aspect of the invention a synergy coil array is employed to generate the receiver response signal. Then the receiver response signal is employed to select the coil element that fits best with the region of interest of the object which is to be imaged.

The receiver response signal is for example generated in a low magnetic resonance imaging acquisition sequence with a low spatial resolution, notably indicated as a ‘scout scan’.

The main advantage of the present invention is that an automatic detection of the coil position can be implemented in existing MR systems without any technical changes.

According to one aspect of the invention a small Field-of-View for a surface coil (3, 5) at the region of interest of a patient on a support movable through the bore of a main magnet, wherein a magnetic resonance signal being generated in an examination zone by means of an RF pulse (7), said magnetic resonance signal subsequently being detected by means of the surface coil and under the influence of magnetic field gradients, characterized in that a non-selective RF-pulse (7) and a first gradient pulse (8) having a linearly independent spatial direction are generated in temporal succession, the position of the surface coil (3, 5) in said spatial direction with respect to the isocenter of the main magnet being determined by the center of gravity of the Fourier transformed response signals detected by the surface coil.

Further gradient pulses (10, 11) in other spatial directions can be applied after application of the first gradient pulse (8).

Notably for each gradient pulse (8, 10, 11) a respective non-selective RF-pulse (7, 7a, 7b) is applied.

For example a subsequent non-selective RF-pulse (7) with a reduced Field-of- View with respect to the first non-selective RF-pulse (7) is applied in order to determine iteratively the spatial position of the surface coil with respect to the isocenter of the main magnet.

According to a further aspect of the invention after determination of the spatial position of the surface coil the patient support is moved automatically in feet-head and/or left/right direction to position the surface coil (3, 5) in the isocenter of the main magnetic field.

For example the magnetic resonance system is arranged to automatically moving the patient support in feet-head and/or left/right direction to position the surface coil (3, 5) in the isocenter of the main magnetic field, dependent from the spatial position of the surface coil.

For example, a computer program product for a magnetic resonance system as claimed in claim 6, characterized in that the computer program determines the spectrum of the magnetic resonance signals detected by the surface coil and Fourier transforms the signals and calculates therefrom, on the basis of the gradient pulses used, the spatial position of the surface coil with respect to the isocenter of the main magnetic field.

These and other advantages of the invention are disclosed in the dependent claims and in the following description in which an exemplified embodiment of the invention is described with respect to the accompanying drawings. Therein shows:

FIG. 1 a schematic picture of a patient with a surface coil in a transverse cross- section,

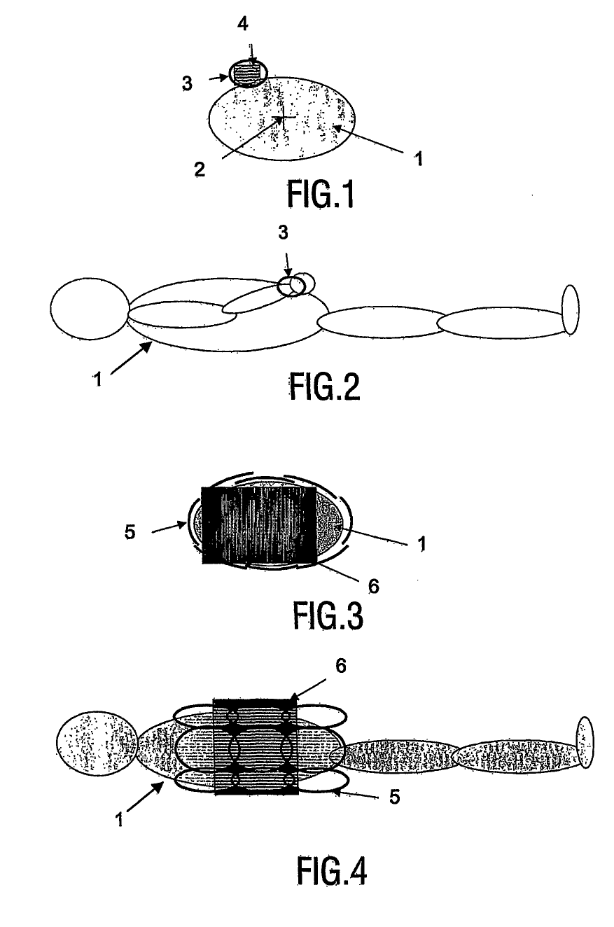

FIG. 2 the same patient as in FIG. 1 in a longitudinal cross-section,

FIG. 3 a schematic picture of a patient with a synergy coil of several elements in a transverse cross-section,

FIG. 4 the same patient as in FIG. 3 in a longitudinal cross-section,

FIG. 5 a pulse sequence for localizing a surface or synergy coil,

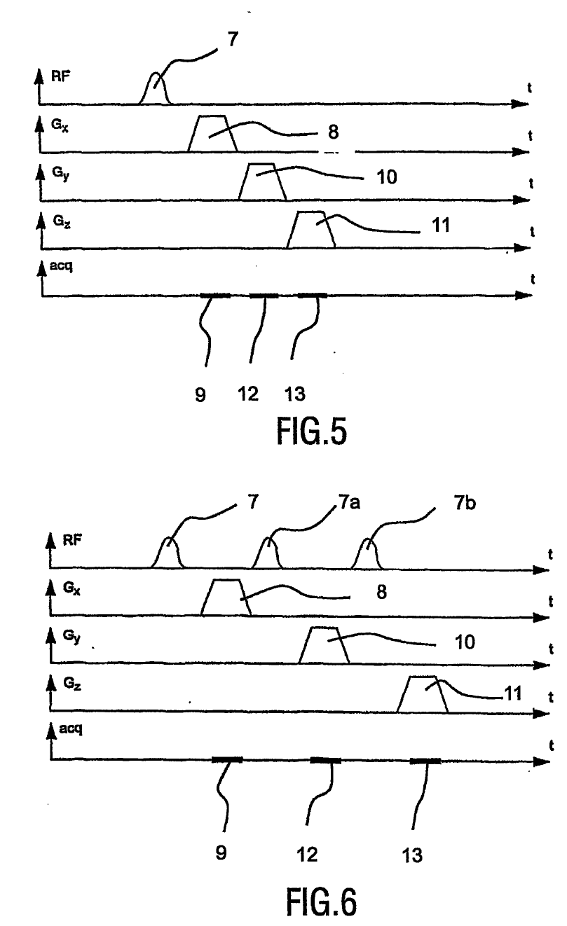

FIG. 6 an alternative localization pulse sequence,

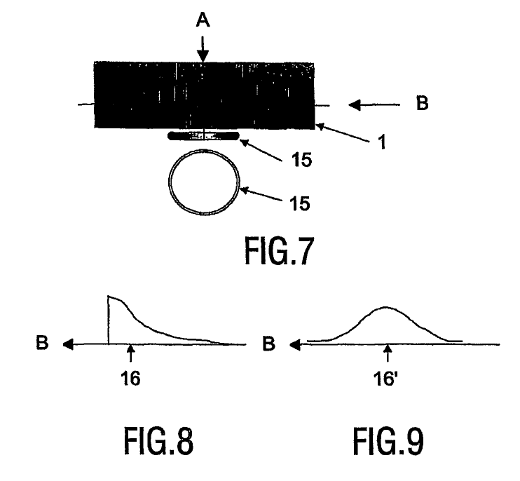

FIG. 7 a schematic view of a patient with a circular surface coil,

FIG. 7a the same circular surface coil in top view,

FIG. 8 the spectrum of the response signals in direction A of FIG. 7,

FIG. 9 the spectrum of the response signals in direction B of FIG. 7,

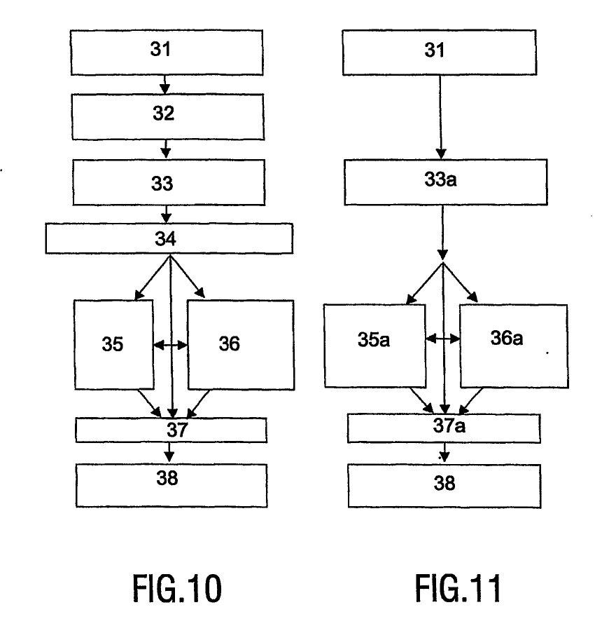

FIG. 10 a flow diagram for automatically determining the spatial position of the surface or synergy coil,

FIG. 11 an alternative flow diagram, and

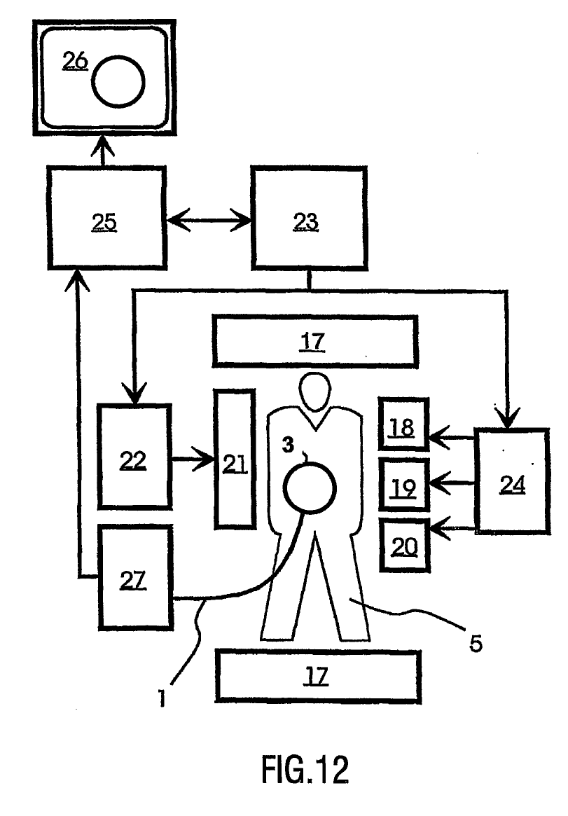

FIG. 12 a block diagram of a magnetic resonance system according to the present invention.

The basic idea of the invention can be explained according to the diagrams in FIGS. 1 and 2, in which a patient I is lying on a patient support (not depicted). The 3 0 isocenter or center of gravity 2 is shown in the cross-sectional view of FIG. 1. A surface coil 3, for example a wrist coil, is applied to the patient 1, whereas the wrist is e.g. positioned on top of the patient's belly or besides his body. Then the patient 1 is moved by the support in direction to a laser visor (not shown). The laser visor is used to detect the correct feet-to-head (FH) position of the surface coil 3. Then the patient 1 is moved by the support to the plane z=0 (i.e. the plane through the x- and y-axes). A region-of-interest 4, that means here the region of the wrist with a small Field-of-View (FOV), is offset in left-/right-direction (L/R) and/or in anterior/posterior-direction (AP). Firstly, a scout scan with a large FOV is performed in order to detect the region of interest. The next scan is planned on the image from this scout scan. This next image is in many cases another scout scan to plan the actual, diagnostic scans. In this way, the coil position can be detected automatically as explained in more detail later.

Another possibility is the use of a synergy coil 5 with many coil elements as is depicted in FIGS. 3 and 4. In the example shown here the synergy coil 5 has an array of three to six coil elements, which however can be extended to sixteen or more if necessary. In case that not all coil elements are used for a specific region or volume of interest 6, the operator can select or deselect these elements specifically. The lower the number of coil elements, the faster the reconstruction of the image is. The more coil elements are used, the higher the signal-to-noise ratio (SNR) and the higher the SENSE factor can be. The selection of the number of coil elements is a balance between SNR, SENSE factor and intended reconstruction time.

The diagram in FIG. 5 illustrates the execution in time of the sequence in accordance with the invention for the localization of the surface coil like a wrist coil as previously described. The upper line shows that the sequence commences with an broad band transmit RF pulse 7 which is not selective, so that magnetization is excited in the entire examination zone. The RF pulse is succeeded by a first gradient pulse 8 which is shown on the next line. The diagrams of the second, the third and the fourth line represent the current through various gradient coils as a function of time. The first gradient pulse 8 concerns a gradient that is applied in the x direction and ensures that the nuclear magnetization in the vicinity of the surface coil performs a precessional motion at a frequency which is directly proportional to the corresponding x co-ordinate. The associated magnetic resonance signal that is induced in the surface coil is then collected for the duration of the first gradient pulse 8. The time intervals in which the data acquisition takes place are shown on the last line of the diagram. The data acquisition for the determination of the x co-ordinate of the surface coil thus takes place in a time interval 9. The spectrum of the signal obtained after Fast Fourier Transformation (FFT) gives a measure of the spin distribution of the tissue in the imaging volume, weighted by the coil sensitivity profile. It is assumed a uniform proton distribution in the body of the patient 1, so that the spectrum shows in fact the coil sensitivity profile. The center of gravity of this sensitivity pattern is a good measure for the position of the coil in the x-direction. The x gradient pulse is succeeded by a y gradient 10 and a z gradient 11 which are associated with the time intervals 12 and 13 for data acquisition. Thus, also the spectra for the y-direction and the z-direction will provide the center of gravity of the respective sensitivity patterns, i.e. a good measure for the position of the coil or coil element in y- and z-direction. This leads to the coordinates (x, y, z) of the coil 3 or coil element in the case of the synergy coil 6. These coordinates can be used in various ways, depending on the intended use.

For regions with more inhomogeneity he alternative sequence as shown in FIG. 6 will be applied. This pulse scheme comprises two further RF pulses 7a and 7b which are irradiated between the data acquisition intervals 9, 12 and 13 respectively. The RF pulses 7a and Tb serve as refocusing pulses in order to create echo signals for data acquisition with an optimal signal to noise ratio. This makes the method applicable even if the magnetic resonance signal dephases rapidly due to strong gradients, which can be applied to obtain a high spatial resolution during the localization of the body or wrist coil 3 or coil elements of the synergy coil 6.

Thus, the acquired position defined co-ordinates in x-, y- and z-direction is the weighted center of the received signal. FIG. 7 shows an example in the direction A and B of the body 1 of the patient, which are perpendicular and parallel to a surface coil 15. The surface coil 15 is shown in FIG. 7A in top view. In FIG. 8 the asymmetric signal distribution in direction A and its weighted center 16 are shown. In FIG. 9 the symmetric signal distribution in direction B and its weighted center 16′ are depicted.

For a wrist coil as shown in FIGS. 1 and 2, the acquired coil position can be used to directly set an offcenter position to perform the second scout scan, or even immediately the final scan. For an open system, which allows a transversal movement of the table or support top, the coil position can be used to move the region of interest to the center of the system for an optimal image quality. This idea can also be used for synergy coils. The synergy coil with a combination of several coil elements behaves like a single coil. With the proposed method the laser visor can be removed. As the table is moved into the main magnet, the position of the coil is continuously detected. The table will be moved automatically until the coil—and the region or volume of interest—is at or in the vicinity of the plane z=0. This method allows for a completely automatic sequential procedure of insert-and-scan: the patient is placed on the table or support top, the coil is applied and the following procedural steps are performed automatically, based on the following flow diagrams, wherein the diagram of FIG. 10 shows the procedural steps with a laser visor and FIG. 11 shows the procedure without a laser visor.

In step 31 the patient is prepared on the table or support top and the coil is applied to the patient Then in step 32 the patient is adjusted according to the light cross of the laser visor. In the following step 33 the region of interest is moved to the plane z=0, whereas in step 33a (FIG. 11) the movement is based on the response of the coil or the coil elements of the synergy coil. In step 34 a first scout scan with a large FOV is performed. In the following step 35 the next scout scan is planned and in step 36 the table is moved, e.g. in lateral direction and a next scout scan is planned. As can be seen from the flow diagram steps 35 and 36 can be performed one after another or can influence each other, or can be left out fully. The corresponding steps in the diagram of FIG. 11 are step 35a in which the offcenter position is determined by the coil response and step 36a in which the table is moved, e.g. in lateral direction, based on the coil response. In step 37 the next scout scan is performed. In case of FIG. 11 step 37a includes that the (only) scout scan is performed. In step 38 the next scans are planned and performed.

Thus, in both flow diagrams it is shown that the centering of the region or volume of interest into the center of the magnet system is performed automatically.

In FIG. 12 another approach is shown, in which the position of each coil element of a synergy coil is known. The coil elements that contribute to the SNR can be selected or deselected automatically, e.g. based on the distance of the coil element to the region of interest. Another possibility is that the coil elements are selected/deselected based on their support/improvement to the SENSE factor in a predetermined direction. Without the above mentioned method the coil elements have to be selected manually, i.e. as part of the examination parameters of a scan. This is especially important when the number of coil elements is increasing. Nowadays, two to five coil elements are used, in future this even may be up to thirty-two elements.

A magnetic resonance system as shown in FIG. 12 is suitable for carrying out the method in accordance with the invention. It includes a coil 17 for generating a steady, uniform magnetic field, gradient coils 18,19 and 20 for generating gradient pulses in the x, the y and the z direction, and an RF transmission coil 21. The temporal succession of the gradient pulses is controlled by means of a control unit 23 which communicates with the gradient coils 18,19 and 20 via a gradient amplifier 24. Furthermore, the control unit is connected to the transmission coil 21 via an RF transmission amplifier 22, so that powerful RF pulses can be generated. The system also includes a reconstruction unit in the form of a microcomputer 25 as well as a visualization unit 16 which may be a graphic monitor. The body or wrist coil 3 is connected to a receiving unit 27 via which the detected signals are possibly demodulated and applied to the reconstruction unit 25. In the reconstruction unit the spin resonance signals are subjected to Fourier analysis so that the wrist coil can be localized while taking into account the applied gradients. The calculated Position of the wrist coil 3 is then displayed on the monitor 26. The reconstruction unit 25 is connected to the control unit 23 so that the position data determined for the imaging method in accordance with the invention can possibly be used for further purposes.

1. A magnetic resonance imaging method involving a field-of-view, wherein
a receiver antenna is employed to acquire magnetic resonance signals from an object to be examined, and
a non-selective RF excitation is applied followed by at least one temporary magnetic gradient field to generate a receiver response signal from the receiver antenna. and
a relative adjustment of the field-of-view and the object to be examined is carried out on the basis of the receiver response signal.

2. A magnetic resonance imaging method as claimed in claim 1, wherein the object is positioned on the basis of the receiver response signal.

3. A magnetic resonance imaging method as claimed in claim 1, wherein the field-of-view is positioned on the basis of the receiver response signal.

4. A magnetic resonance imaging method as claimed in claim 1, wherein a surface receiver coil is employed as the receiver antenna.

5. A magnetic resonance imaging method as claimed in claim 1, wherein
a synergy coil having several coil elements is employed as the receiver antenna,
the receiver response signals are generated from individual coil elements, and
coil elements are selected on the basis of the receiver response signals.

6. A magnetic resonance imaging system involving a field-of-view, comprising
a receiver antenna to acquire magnetic resonance signals from an object to be examined, and
an RF transmission system to generate a non-selective RF excitation followed by at least one temporary magnetic gradient field to generate a receiver response signal from the receiver antenna, and
and a control unit to calculate a relative adjustment of the field-of-view and the object to be examined is carried out on the basis of the receiver response signal.

7. A computer programme comprising instructions to
activate an RF transmission system to generate a non-selective RF excitation followed by at least one temporary magnetic gradient field to generate a receiver response signal from the receiver antenna, and
and calculate a relative adjustment of the field-of-view and the object to be examined is carried out ion the basis of the receiver response signal.
